(19) United States
(12) Patent Application Publication
(10) Pub. No.: US 2018/0349956 A1
(43) Pub. Date: Dec. 6, 2018

(54) METHOD AND SYSTEM FOR PROVIDING NOTIFICATIONS TO A MOBILE DEVICE LOCATED IN A ZONED AREA

(71) Applicant: Mastercard International Incorporated, Purchase, NY (US)

(72) Inventors: Prashant SHARMA, Madison, NJ (US); Vitorino Jose Pereira LOPES, Brookfield, CT (US); Manash BHATTACHARJEE, Jersey City, NJ (US); Joseph HAYES, Montclair, NJ (US)

(73) Assignee: Mastercard International Incorporated, Purchase, NY (US)

(21) Appl. No.: 15/613,811

(22) Filed: Jun. 5, 2017

(51) Int. Cl. G06Q 30/02; G06Q 20/32; G06Q 30/06

(52) U.S. Cl. CPC G06Q 30/0267; G06Q 30/0601; G06Q 20/322

(57) ABSTRACT

A method includes, receiving one or more merchant profiles, wherein each merchant profile includes data related to a related merchant including at least a respective merchant identifier, a respective merchant geolocation, and one or more payment methods accepted by the respective merchant as a form of payment; determining a geolocation associated with a mobile device of a consumer; identifying a first merchant profile, of the one or more merchant profiles, associated with a first merchant, wherein the geolocation associated with the mobile device of the consumer corresponds to the merchant geolocation included in the identified first merchant profile; transmitting an indication of the one or more payment methods accepted by the first merchant as a form of payment; and causing the mobile device of the consumer to output information associated with the one or more payment methods accepted by the first merchant.

### FIELD

The present disclosure relates to notifying a device of a merchant's acceptable payment methods, and specifically to generating, by the device, an output of the types of payment methods accepted by the merchant, where the device is located at the merchant's physical location.

### BACKGROUND

More and more types of payment methods are becoming available in today's society. While traditional payment methods of cash, check, or credit card are generally accepted by most merchants, many merchants are turning to alternative or newer payment methods, such as digital wallets. In today's world, many merchants sell items online through a website. When a consumer visits a checkout webpage or views an online shopping cart on a merchant's website, the checkout webpage or the shopping cart may display the types of payment methods that are available to use to purchase the items on the merchant's website.

Such systems and methods, however, do not inform consumers who shop at a physical merchant location of the types of payment methods accepted at the physical merchant location. In such situations, where a user physically enters a merchant location, the user might not know the types of payment methods that the merchant accepts. Conventional methods of notifying a consumer at a physical location may include placing stickers on a cash register at the front of the store, such as to physically display which types of credit cards a merchant may accept for payment at the cash register. But these conventional methods have many downsides.

Because of the growing number of different digital wallet and electronic payment applications, many merchants may find that they cannot display or otherwise communicate to a consumer all of the types of payment methods that the merchant accepts. This leads to consumers asking questions to a clerk at checkout about what are the acceptable payment options and seeking to find out if there are any discounts or incentives for using a particular payment option. This exchange can take several minutes and can lead to misinformation, such as when the clerk might not know all of the types of acceptable payment options, or may lead to the clerk asking another clerk or manager for the information. This can create a very inefficient checkout process, which can cause frustration and long lines, which may discourage shoppers waiting in line from coming back to the store to shop. These consequences can lead to businesses losing money on their bottom line, which can lead to businesses having to cut costs, which may lead to some employees losing their jobs. Some consequences may even cause effects on the regional or national economy.

Thus, there is a need for a technical solution where a user can immediately know the types of payment methods accepted by a merchant when the consumer enters the merchant's physical location. Furthermore, as more and more different types of payment options are established, it is inevitable that competition among the developers of these payment options will increase. Thus, there is a further need for a technical solution where incentives or promotions associated with these various payment options are communicated to a consumer when the consumer is at the merchant's physical location. Such technical solutions will benefit consumers, businesses, and the overall economy.

### SUMMARY

The present disclosure provides a description of systems and methods for providing a merchant's accepted forms of payment to a mobile device located at a merchant location. Providing a merchant's accepted forms of payment to a consumer's mobile device may enable the consumer to know the payment types and methods that the merchant accepts after the user enters a physical store or a merchant location, and potentially be able to deliver communications making one more attractive than the other potentially in real time. This is far superior technology to using static stickers or the like.

A method for providing accepted forms of payment to a mobile device at a merchant location, includes: receiving, in a merchant database by a receiving device, one or more merchant profiles, wherein each merchant profile includes data related to a related merchant including at least a respective merchant identifier, a respective merchant geolocation, and one or more payment methods accepted by the respective merchant as a form of payment; determining, by a processing device, a geolocation associated with a mobile device of a consumer; identifying, in the merchant database by the processing device, a first merchant profile, of the one or more merchant profiles, associated with a first merchant, wherein the geolocation associated with the mobile device of the consumer corresponds to the merchant geolocation included in the identified first merchant profile; transmitting, by a transmitting device to the mobile device of the consumer, an indication of the one or more payment methods accepted by the first merchant as a form of payment; and causing, responsive to the indication, the mobile device of the consumer to output information associated with the one or more payment methods accepted by the first merchant.

A system for providing accepted forms of payment to a mobile device at a merchant location, includes: a receiving device configured to receive, in a merchant database, one or more merchant profiles, wherein each merchant profile includes data related to a related merchant including at least a respective merchant identifier, a respective merchant geolocation, and one or more payment methods accepted by the respective merchant as a form of payment; a processing device configured to: determine a geolocation associated with a mobile device of a consumer, and identify, in the merchant database, a first merchant profile, of the one or more merchant profiles, associated with a first merchant, wherein the geolocation associated with the mobile device of the consumer corresponds to the merchant geolocation included in the identified first merchant profile; and a transmitting device configured to transmit, to the mobile device of the consumer, an indication of the one or more payment methods accepted by the first merchant as a form of payment. The processing device is further configured to cause, responsive to the indication, the mobile device of the consumer to output information associated with the one or more payment methods accepted by the first merchant.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for a platform for providing a mobile electronic device a notification of the payment methods that a merchant accepts at a physical location in accordance with exemplary embodiments.

FIG. 2 is a block diagram illustrating the merchant system of FIG. 1 for providing a mobile electronic device a notification of the payment methods that a merchant accepts at a physical location in accordance with exemplary embodiments.

FIG. 3 is a block diagram illustrating the payment network processing server of FIG. 1 for providing a mobile electronic device a notification of the payment methods that a merchant accepts at a physical location in accordance with exemplary embodiments.

FIG. 4 is a block diagram illustrating the mobile computing device of FIG. 1 for the initiation of a notification of the payment methods that a merchant accepts at a physical location in accordance with exemplary embodiments.

FIG. 5 is a block diagram illustrating a system architecture of a mobile electronic device receiving notifications of a merchant's accepted forms of payment when the mobile electronic device is at the merchant's location.

FIG. 6 is a flow chart illustrating an exemplary method for providing a mobile electronic device a notification of the payment methods that a merchant accepts at a physical location in accordance with exemplary embodiments.

FIGS. 7A and 7B are exemplary graphical merchant portal interfaces in accordance with exemplary embodiments.

FIGS. 8A, 8B, and 8C illustrate exemplary graphical user interfaces, which may be displayed on a display of a mobile electronic device in accordance with exemplary embodiments.

FIG. 9 is a flowchart illustrating an exemplary method for providing payment method notifications to a mobile electronic device in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant might not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

### System for Providing Payment Method Notifications to a Mobile Device

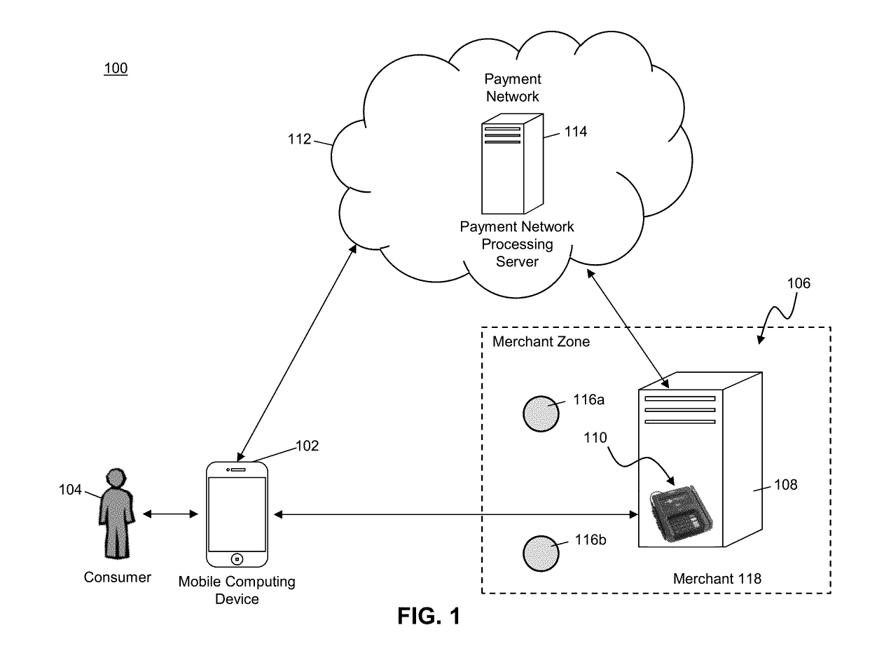

FIG. 1 illustrates a system 100 for providing accepted forms of payment to a computing device (e.g., a mobile electronic device) that may be associated with a consumer and may be located at a merchant location.

The system 100 may include a mobile computing device 102. The mobile computing device 102, discussed in more detail below, may be configured to receive an indication of the payment methods that are accepted by a merchant 118 or a merchant system 108, such as by a point of sale device 110 located within a merchant's zone 106 (shown by with a dashed line in FIG. 1), which will be discussed below in more detail. According to aspects discussed herein, the point of sale device 110 may be configured to perform some or the same functions as the merchant system 108, or may be configured to work in coordination with the merchant system 108.

The mobile computing device 102 may receive indications of acceptable payment methods when an associated consumer 104 accesses the merchant zone 106 to browse items prior to initiating a payment transaction at the merchant 118 and/or a location (e.g., physical location) associated with the merchant 118, such as initiating a payment transaction via a merchant system 108 or point of sale device 110. According to some aspects, the merchant system 108 and/or the point of sale device 110 may be an automated teller machine (ATM).

The mobile computing device 102 may be any type of mobile device suitable for performing the functions discussed herein, such as a cellular phone, smart phone, tablet computer, laptop computer, smart watch, wearable computing device, implantable computing device, etc. The payment methods that are accepted by the merchant system 108 may be any type of payment method or option suitable for initiating and/or completing a payment transaction, such as cash, check, credit card (e.g., MASTERCARD, VISA, AMEX, etc.), debit card, digital wallet and/or application (e.g., PAYPAL, APPLE PAY, SAMSUNG PAY, ALIPAY, MASTERPASS, etc.), a card or application specific for the merchant (e.g., WALMART pay application or WALMART credit card), QR payment methods, Fast ACH contactless, etc. Methods suitable for the installation and the provisioning of digital and/or electronic payment methods and applications on a mobile computing device 102 will be apparent to persons having skill in the relevant art.

The consumer 104 may take the mobile computing device 102 into a merchant zone 106 associated with a merchant system 108. The merchant zone 106 may be a geofenced area, which may be an area defined by a geographic location. In some instances, the geofenced area may be associated with a visible physical area, such as a building or a fenced area, or may be associated with the range of a wireless signal, such as various types of cellular, WiFi, BlueTooth, or other type of signal protocols, or mixtures thereof, that have a defined range at a predetermined signal strength wherein the outer boundary of the range can be made to match a desired geographic, virtual fence or area by controlling transmission power, selectively placing antennas, using repeaters and/or multiple frequencies or multiplexing schemes, and the like. For example, one or more transmitters 116a and 116b may be located around a merchant's venue and may generate signals and data, which may communicate to other devices, such as the mobile computing device 102, an indication of the merchant zone 106 and/or other data, such as the payment methods accepted by the merchant 118 and any promotions associated with the merchant 118. In some embodiments the transmitters 116a and 116b may form part of a Bluetooth™ Low Energy (BLE) Beacon Network and may transmit data according to the iBeacon protocol of Apple, Inc. or the Eddystone format of Google, Inc. In some embodiments the merchant system 108 or the point of sale device 110 may include one or more transmitters, such as the transmitters 116a and 116b, and may generate and communicate signals and data to the mobile computing device 102, where responsive to detecting and being capable of communicating with the mobile computing device 102, the merchant system 108 or the point of sale device 110 may determine that the mobile computing device 102 is at or within the merchant zone 106 and/or at the merchant's geolocation. In some embodiments, the merchant zone 106 may be manually defined, such as by a user of the merchant system 108 that may input geographic coordinates into the merchant system 108 (e.g., defined by latitude and longitude), drawing a geographic representation on an electronic map as is known, or other suitable representations for the merchant zone 106. The mobile computing device 102 may self-report to the merchant device 108 or to a payment network processing server 114 that the mobile computing device 102 has passed into a defined merchant zone 106, such as via a broadcast or point-to-point transmission, or via use of the geolocation detecting mechanism of a user's mobile device, for example. In some embodiments, the payment network processing server 114 may receive information from the merchant system 108 indicating that the mobile computing device 102 has entered the merchant zone 106. In some instances, communications between the merchant device 108/point of sale device 110 and the mobile computing device 102 may utilize one or more application programming interfaces (APIs). In other embodiments, the merchant zone 106 may be generated via one or more suitable methods, such as those described in: U.S. patent application Ser. No. 13/969,839, entitled “Method and System for Geolocation Mapping of Indoor Locations Using Payment Data,” by Justin X. Howe, filed Aug. 19, 2013; U.S. patent application Ser. No. 14/040,328, entitled “Generating Geofences,” by Shuvo Cahtterjee et al., filed Sep. 27, 2013; and U.S. patent application Ser. No. 13/826,671, entitled “Geolocation Check-In System,” by Scott Lee Harkey et al., filed Mar. 14, 2013, each of which are herein incorporated by reference in their entirety.

Upon entry into the merchant zone 106, the merchant system 108 and/or the payment network processing server 114 may detect the mobile computing device 102. Methods for detecting a geographic location or entry into a defined geographic area of a computing device will be apparent to persons having skill in the relevant art. For instance, the mobile computing device 102 may report the mobile device's geographic location to the merchant system 108 using a suitable method, such as via a local area network or a cellular communication network, directly or via one or more intermediate entities and/or systems (e.g., via the payment network processing server 114, via the transmitters 116a, via the point of sale device 110, via another mobile computing device 102, via a mobile network operator, via an issuer, via an acquirer, etc.), and the merchant system 108 may identify when the mobile computing device's geographic location is within the merchant zone 106. In another example, the merchant system 108 may monitor for any electronic device inside the payment zone 106, such as via the use of a wireless area network, radio frequency network, Bluetooth, etc. and may detect the mobile computing device 102 when the mobile computing device 102 appears to the merchant system 108. In some embodiments, the payment network processing server 114 and/or the merchant system 108 may determine the geolocation associated with the mobile device 102 via one or more methods apparent to persons having skill in the relevant art.

After the merchant system 108 or the payment network processing server 114 determines that the geolocation associated with the mobile computing device 102 is within the merchant zone 106, the merchant system 108 or the payment network processing server 114 (e.g., via the merchant system 108) may transmit to the mobile computing device 102 an indication of the payment methods accepted as a form of payment by the merchant system 108.

According to some embodiments, the payment network processing server 114 may determine the payment methods accepted by the merchant system 108 by receiving from the merchant system 108 (e.g., via the point of sale device 110) transaction data associated with previous payment transactions involving the merchant system 108. In these embodiments, the payment network processing server 114 may identify the payment methods used in these transactions for a respective merchant, and may store these identified payment methods in a merchant database according to a respective merchant ID in a profile for that merchant. According to some aspects, the merchant system 108 may store data in a merchant database as similarly described above.

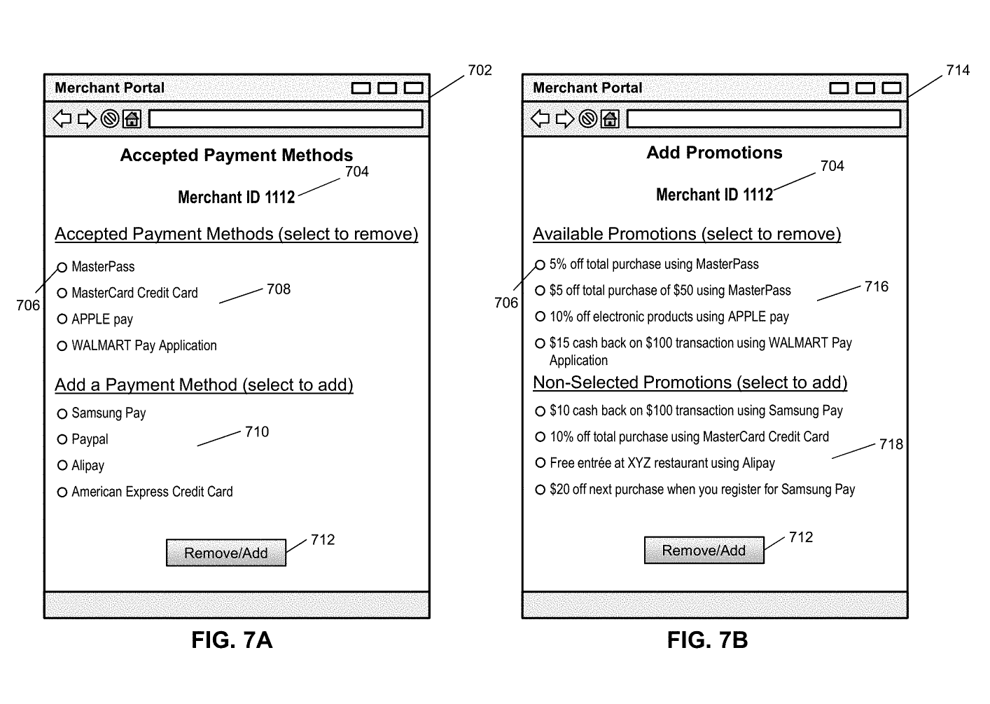

According to some embodiments, a user associated with the merchant system 108 may input or configure, via a merchant portal or application, payment method information, such as via a web site, via an application program stored locally on the merchant system 108 or externally to the merchant system 108, and the like, such as illustrated in FIGS. 7A and 7B, which will be discussed below in more detail. For example, a user associated with the merchant system 108 may select and/or remove accepted payment methods that the merchant system 108 may accept as a form of payment in a payment transaction. In another example, a user associated with the merchant system 108 may select and/or remove promotions, discounts, or coupons (and/or other data) associated with payment methods via the merchant portal.

In some embodiments, after receiving the indication of the payments methods accepted by the merchant system 108, the mobile computing device 102 may output information associated with the acceptable payment methods. For example, the mobile computing device 102 may generate a display showing the types of payment methods accepted by the merchant system 108 and/or associated data, such as related promotions for these payment methods. In another example, the mobile computing device 102 may generate an audible sound via an audio device (e.g., a speaker), which may indicate or utter the types of payment methods accepted by the merchant system 108 and/or associated data, such as related promotions for these payment methods. According to some embodiments, the mobile computing device 102 may output a promotion that provides a greater promotion value or greater discount than other available promotions. For example, the consumer 104 may input into the mobile computing device 102 a specific combination of one or more products offered for sale by the merchant 118 at the merchant's venue, and the mobile computing device 102 may display a promotion (along with an associated acceptable form of payment) that provides to the user a greater discount in cost for that specific combination of products.

In some embodiments, a merchant system 108 may accept as a form of payment a digital wallet or digital application method of payment, such as MASTERPASS, ALIPAY, APPLE PAY, ANDROID PAY, etc. For example, the merchant system 108 may transmit to the mobile computing device 102 an indication that the merchant system 108 accepts MASTERPASS as a type of payment method. After receiving this indication, the mobile device may open or execute a MASTERPASS application, and in some embodiments, any associated promotions may be displayed. In some embodiments, if the mobile computing device 102 might not have a MASTERPASS application installed, and the indication may cause the mobile device to generate a prompt requesting that a MASTERPASS application be downloaded or installed. In some embodiments, an associated promotion may also be displayed along with this prompt, which may entice the user 104 to download the MASTERPASS application. In some embodiments, if the mobile computing device 102 has the MASTERPASS application installed, but the mobile computing device 102 might not be associated with a MASTERPASS account, the indication may cause the mobile computing device 102 to generate a prompt (e.g., along with any promotion details) requesting that the user 104 register an account for MASTERPASS.

The merchant system 108 and/or the payment network processing server 114 may determine that mobile computing device 102 has exited the merchant zone 106 using the same methods and protocols used to detect entry into the merchant zone 106, such as by identifying the mobile computing device 102's geographic location as compared to the merchant zone 106's geofenced area (shown by the dashed line in FIG. 1), via lack of detection of the mobile computing device 102 (e.g., by transmitters 116a), via self-reporting, etc. Once it is determined that the mobile computing device 102 has left the merchant zone 106, the merchant system 108 and/or the serve 114 may cease transmitting the indication of the payment methods accepted by the merchant system 108 and/or any associated data (e.g., promotions, etc.). In some embodiments, the ceasing may be automatic. In some embodiments, if the mobile computing device 102 then re-enters the merchant zone 106, the merchant system 108 and/or payment network processing server 114 may transmit an indication of the payment methods accepted by the merchant system 108 and/or any associated data. In some embodiments, the user 104 may conduct a financial transaction with one or more of the accepted payment methods. For example, the user may use cash or credit card if these are types of acceptable payment methods. In another example, the user may conduct a financial transaction using a digital wallet application at the point of sale device 110 if this is an acceptable payment method.

In some embodiments, the merchant system 108 and/or the payment network processing server 114 may determine that the mobile computing device 102 has previously engaged in a transaction with a particular payment method accepted by the merchant system 108. For example, the merchant system 108 and/or payment network processing server 114 may store in a profile data profiles for mobile devices (e.g., in accordance with a mobile device ID), such as mobile devices (and/or associated consumers) that have previous conducted a financial transaction and the type of payment method used in that financial transaction. In some embodiments, the payment network processing server 114 may transmit this information and other information to the merchant system 108. In some embodiments, the merchant system 108 and/or the payment network processing server 114 may transmit information associated with this previously used payment method, such as promotions, other merchants that may accept this payment method, etc. In some embodiments, the merchant system 108 and/or the payment network processing server 114 may determine that a mobile device 102 may prefer a payment method over other types of payment methods, such as by determining that the mobile device 102 may have used a type of payment method in a more frequent manner. In such scenarios, the merchant system 108 and/or the payment network processing server 114 may cause a corresponding electronic application to open on the mobile device 102 when the mobile device 102 enters the merchant zone 106.

According to some embodiments, aspects discussed herein where applicable to and/or performed by the merchant system 108 may also be applicable to and/or performed by the payment network processing server 114.

### Merchant System Device

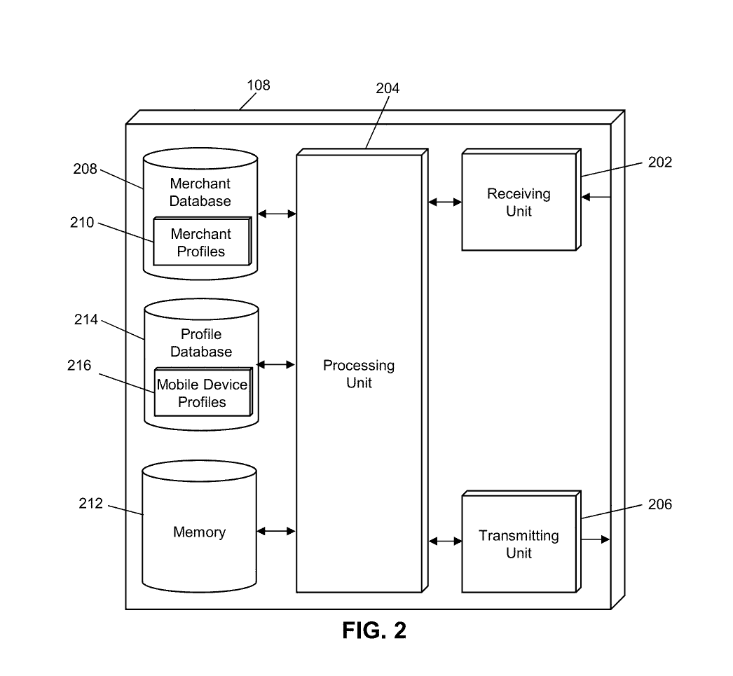

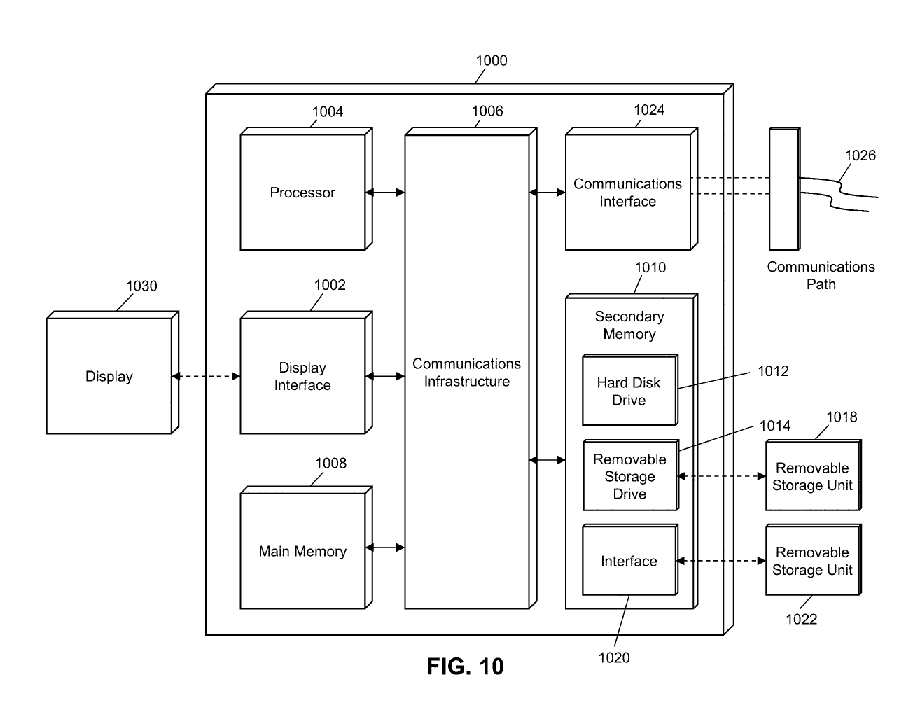

FIG. 2 illustrates an embodiment of the merchant system device 108 of the system 100. It will be apparent to persons having skill in the relevant art that the embodiment of the merchant system 108 illustrated in FIG. 2 is provided as illustration only and might not be exhaustive to all possible configurations of the merchant system 108 suitable for performing the functions as discussed herein. For example, the computer system 1000 illustrated in FIG. 10 and discussed in more detail below may be a suitable configuration of the merchant system 108.

The merchant system 108 may include a receiving unit 202. The receiving unit 202 may be configured to receive data over one or more networks via one or more network protocols. In some embodiments, the receiving unit 202 may be configured to receive data over the payment rails. The receiving unit 202 may be configured to receive data related to merchants, such as a merchant identifier, a respective merchant geolocation, and one or more payment methods accepted by a respective merchant as a form of payment. The receiving unit 202 may also receive information identifying at least one promotion associated with each merchant and the one or more acceptable payment methods for each merchant. The receiving unit 202 may be configured to receive transaction data for payment transactions involving the consumer 102 and one or more merchants 104. The transaction data may be received from a payment network, such as during the processing of a payment transaction with the mobile computing device 102. In some embodiments, the receiving unit 202 may receive transaction data associated with a specific combination of products offered for sale at the merchant geolocation, such as from the mobile computing device 102. The receiving unit 202 may also receive data associated with a geographic location of the mobile computing device 102.

The merchant system may include a transmitting unit 206. The transmitting unit 206 may be configured to transmit data over one or more networks via one or more network protocols, such as to the mobile computing device 102 and/or to the payment network processing server 114. In some embodiments, the transmitting unit 202 may be configured to transmit data over the payment rails. For example, the transmitting unit 206 may be configured to transmit to the mobile computing device 102 an indication of the payment methods accepted by a particular merchant (e.g., the merchant 118) as a form of payment and/or any associated data (e.g., promotions associated with the acceptable payment methods, other merchants, etc.). In some embodiments, the transmitting unit 206 may be configured to transmit this indication to the mobile device by transmitting a beacon via near field communication, via Bluetooth communication, via Bluetooth low energy (BLE) communication, via a wireless local area network communication, or the like.

The merchant system 108 may also include a merchant database 208. The merchant database 208 may include one or more merchant profiles 210. Each merchant profile 210 may be configured to store data related to a merchant (e.g., merchant 118) via a merchant identifier, and the data may include at least a geolocation associated with the related merchant 118. The geolocation may be a physical location or locations of the related merchant 118 and may be represented by latitude and longitude, street address, postal code, zip code, or any other suitable type of geographic representation. Each merchant profile 210 may include the type of payment methods accepted for a respective merchant and any associated data (e.g., promotions, discounts, etc.). Each merchant profile 210 may include transaction data related to items offered for sale at a respective merchant. For example, the transaction data may include prices or transaction terms for products offered for sale at or by a respective merchant.

The merchant system may include a profile database 214. The profile database 214 may include one or more mobile device profiles 216. Each mobile device profile 216 may be configured to store data related to a respective mobile computing device 102 including at least transaction details associated with the mobile computing device 102, such as a merchant ID associated with a financial transaction and/or a payment method used in a respective financial transaction.

The merchant system 108 may also include a processing unit 204. The processing unit 204 may be configured to perform the functions of merchant system 108 discussed herein as will be apparent to persons having skill in the relevant art. The processing unit 204 may be configured to determine a geolocation associated with a mobile computing device 102 associated with a user 104, such as via one or more of the transmitters 116a and 116b. The processing unit 204 may be configured to identify a first merchant profile in the merchant database, where the geolocation associated with the mobile computing device 102 corresponds to the merchant geolocation included in the first merchant profile. The processing unit 204 may be configured to instruct the transmitting unit 206 to send to the mobile computing device 102 an indication of the payment methods accepted by the first merchant and any associated data, where this indication may cause the mobile computing device 102 to output information associated with the payment methods.

The processing unit 204 may be configured to determine whether a first promotion or a second promotion associated with a first merchant provides a greater promotion or discount value, such as for a specific combination of items offered for sale at a respective merchant. For example, the processing unit 204 may be configured to cause the mobile computing device 102 to output information associated with a first promotion when the first promotion provides a greater discount in cost, such as for a specific user 104. In some of these scenarios, information associated the second promotion might not be outputted (i.e., only information associated with the first promotion may be outputted). Similarly, the processing unit 204 may be configured to cause the mobile computing device 102 to output information associated with the second promotion when the second promotion provides a greater discount in cost. In some of these scenarios, information associated with the first promotion might not be outputted (i.e., only information associated with the second promotion might be outputted).

The processing unit 204 may be configured to identify, from transaction data received by the receiving unit 202, the payment methods used in one or more transactions involving a respective merchant, such as merchant 118. The processing unit 204 may be configured to determine that the mobile computing device 102 has previously engaged in a payment transaction with a particular payment method, such as one accepted by a particular merchant (e.g., merchant 118). The processing unit 204 may be configured to identify in the merchant database another merchant that accepts the particular payment method accepted by the merchant 118, and may transmit an indication that the other merchant accepts that particular payment method. In some embodiments, the other merchant may be associated with a geolocation that may correspond to the geolocation of the mobile computing device 102, such as nearby, within a predetermined distance, within a merchant zone associated with the other merchant, etc. In some embodiments, the other merchant may offer for sale goods different from the goods offered for sale by the merchant 118. For example, the merchant 118 may be café, and the other merchant may be a grocery store. In some embodiments, the other merchant may offer for sales goods similar to or the same as the goods offered for sale by the merchant 118, such as a competitor, or may be a second location associated with a merchant brand for the merchant 118. In some embodiments, the processing unit 204 may cause (e.g., via the indication transmitted by the transmitting unit 206) the mobile computing device 102 to output any promotions associated with the accepted payment method and with the other merchant.

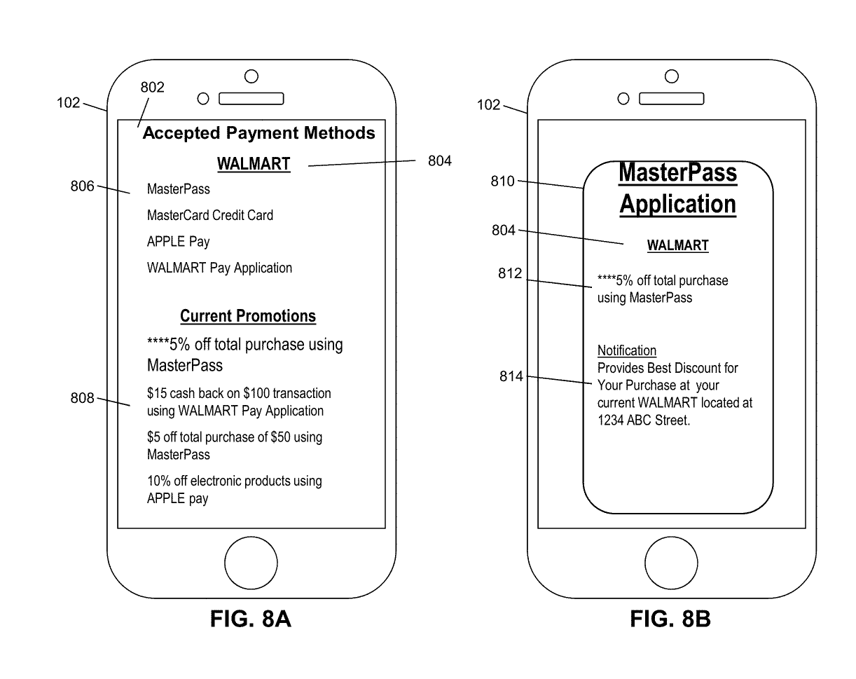

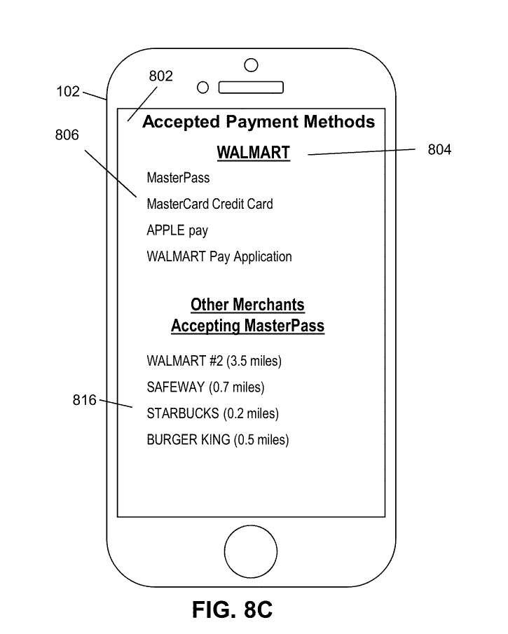

The processing unit 204 may be configured to cause the mobile computing device 102 to generate a display of the payment methods (and any related data, such as associated promotions, etc.) accepted by the first merchant, such as illustrated in FIGS. 8A-8C, which will be discussed below in more detail. In some embodiments, the processing unit 204 may be configured to cause the mobile computing device 102 to generate an audible sound associated with the payment methods accepted by the first merchant, such as via a speaker. For example, the audible sound may state the types of payments method and any associated data (e.g., promotions, etc.) associated with the payment methods accepted by the first merchant. In some embodiments, the processing unit 204 may be configured to cause the mobile computing device 102 to execute a payment application, such as one associated with a digital wallet payment method accepted by the merchant 118. In some embodiments, the processing unit 204 may be configured to cause the mobile computing device 102 to generate a prompt requesting installation or registration of one or more applications associated with a payment method, such as one associated with a digital wallet payment method accepted by the merchant 118. In such embodiments, the processing unit 204 may be configured to determine whether the mobile computing device 102 has a type of payment method application installed prior to triggering the execution of the application or the generation of a prompt requesting installation or registration of a payment method application.

The merchant system 108 may also include a memory 212. The memory 212 may be configured to store data suitable for performing the functions disclosed herein. For example, the memory 212 may include merchant industry rules or settings, product association data, notification data, etc., and additional data that will be apparent to persons having skill in the relevant art.

### Payment Network Processing Server Device

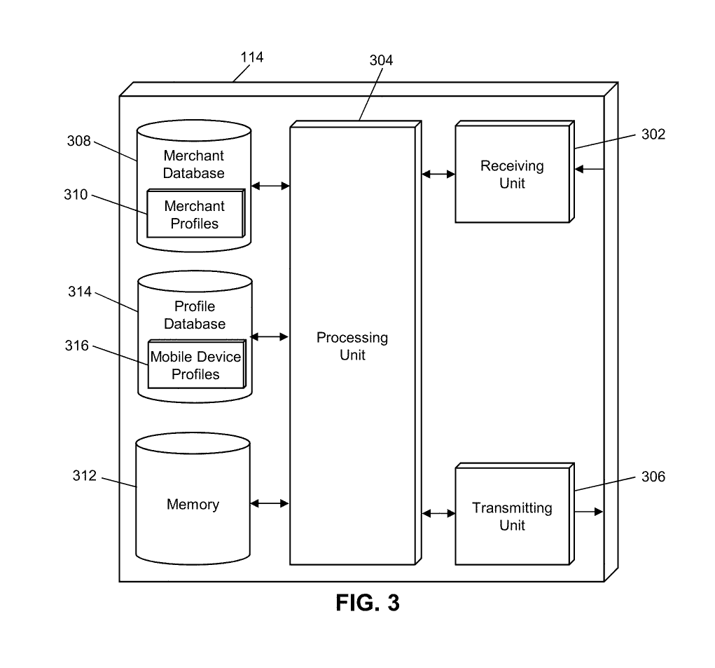

FIG. 3 illustrates an embodiment of the payment network processing server 114 of the system 100. It will be apparent to persons having skill in the relevant art that the embodiment of the payment network processing server 114 illustrated in FIG. 3 is provided as illustration only and might not be exhaustive to all possible configurations of the payment network processing server 114 suitable for performing the functions as discussed herein. For example, the computer system 1000 illustrated in FIG. 10 and discussed in more detail below may be a suitable configuration of the payment network processing server 114.

The payment network processing server 114 may include a receiving unit 302, processing unit 304, transmitting unit 306, merchant database 308, which may include one or more merchant profiles 310, a memory 312, and a profile database 314, which may include one or more mobile device profiles 316. As described above and hereinafter, the components of the payment network processing server 114 may perform functions similar to the functions performed by the corresponding components of the merchant system 108. As such, in the interest of brevity, the description of these components will not be described here with respect to FIG. 3.

### Mobile Computing Device

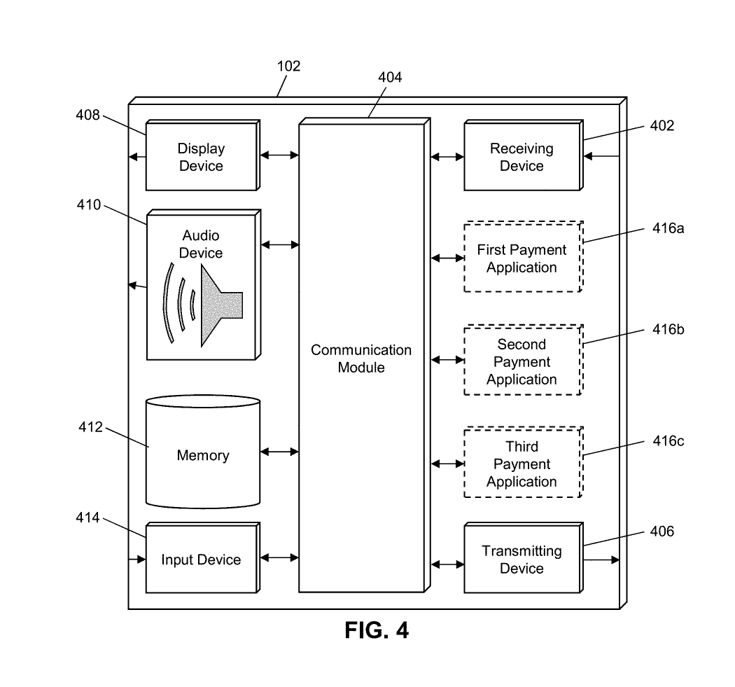

FIG. 4 illustrates an embodiment of the mobile computing device 102 of the system 100. It will be apparent to persons having skill in the relevant art that the embodiment of the mobile computing device 102 illustrated in FIG. 2 is provided as illustration only and might not be exhaustive to all possible configurations of the mobile computing device 102 suitable for performing the functions as discussed herein. For example, the computer system 1000 illustrated in FIG. 10 and discussed in more detail below may be a suitable configuration of the mobile computing device 102.

The mobile computing device 102 may include a receiving device 402. The receiving device 402 may be configured to receive data over one or more networks via one or more network protocols. In some embodiments, the receiving device 402 may be configured to receive data over the payment rails. The receiving device 402 may be configured receive an indication of the payment methods accepted by a particular merchant (e.g., the merchant 118) and any associated information (e.g., promotions, etc.). The receiving device 402 may be configured to receive transaction data associated with one or more products or items offered for sale at a merchant location, such as from a user 104 via a user interface or portal.

The mobile computing device 102 may include a transmitting device 406. The transmitting device 406 may be configured to transmit data over one or more networks via one or more network protocols. In some embodiments, the transmitting device 406 may be configured to transmit data over the payment rails. The transmitting device 406 may be configured to transmit data associated with a geolocation associated with the mobile computing device 102, such as to the payment network processing server 114 and/or to the merchant system 108. The transmitting device 406 may be configured to transmit transaction data associated with one or more products or items offered for sale at a merchant location. For example, after the user 104 has input transaction data for a specific combination of items, the transmitting device 406 can transmit this data to the payment network processing server 114 and/or to the merchant system 108.

The mobile computing device 102 may include a communication module 404. The communication module 404 may be configured to transmit data between modules, engines, databases, memories, and other components of the mobile computing device 102 for use in performing the functions discussed herein. The communication module 404 may be comprised of one or more communication types and utilize various communication methods for communications within a computing device. For example, the communication module 404 may be comprised of a bus, contact pin connectors, wires, etc. In some embodiments, the communication module 404 may also be configured to communicate between internal components of the mobile computing device 102 and external components of the mobile computing device 102, such as externally connected databases, display devices, input devices, etc. The mobile computing device 102 may also include a processing device. The processing device may be configured to perform the functions of the mobile computing device 102 discussed herein as will be apparent to persons having skill in the relevant art. In some embodiments, the processing device may include and/or be comprised of a plurality of engines and/or modules specially configured to perform one or more functions of the processing device.

The mobile computing device 102 may include a display device 408. The display device 408 may be configured to display graphics, text, pictures, or any other data or information, such as information associated with one or more payment methods accepted by a merchant and any associated data. For example, the display device 408 may display a generated graphical user interface.

The mobile computing device 102 may include an audio device 410. The audio device 410 may be a speaker or other type of sound producing device. The audio device 410 may be configured to generate audible sounds associated with information, such as one or more payment methods accepted by a merchant and any associated data.

The mobile computing device 102 may also include a memory 412. The memory 412 may be configured to store data for use by the mobile computing device 102 in performing the functions discussed herein.

The mobile computing device 102 may also include an input device 414. The input device 414 may be configured to receive input from the consumer 104 for use in conjunction with the functions of the mobile computing device 102 as discussed herein. The input device 414 may be, for example, a keyboard, click wheel, scroll wheel, track pad, microphone, camera, capacitive touch display, stylus, etc. In some instances, the mobile computing device 102 may include more than one input device 414, where each input device 414 may be the same or one of a plurality of different types. The input device 414 may be configured to receive input from the consumer 104, such as indicating transaction data or the acceptance or denial of a payment transaction, such as associated with using or executing a payment method.

The mobile computing device 102 may also include one or more payment applications, such as the first payment application 416a, the second payment application 416b, and the third payment application 416c, which may be installed on the mobile computing device 102, such as via the memory 412. For example, the mobile computing device 102 may use the first payment application at a merchant location (e.g., via the point of sale device 110 associated with the merchant system 108) when the merchant system 108 accepts the first payment application as a form of payment for a payment transaction. In some embodiments, a one of the payment application 416a-c may correspond to a digital wallet application, which may be used in a payment transaction.

### Merchant Zones

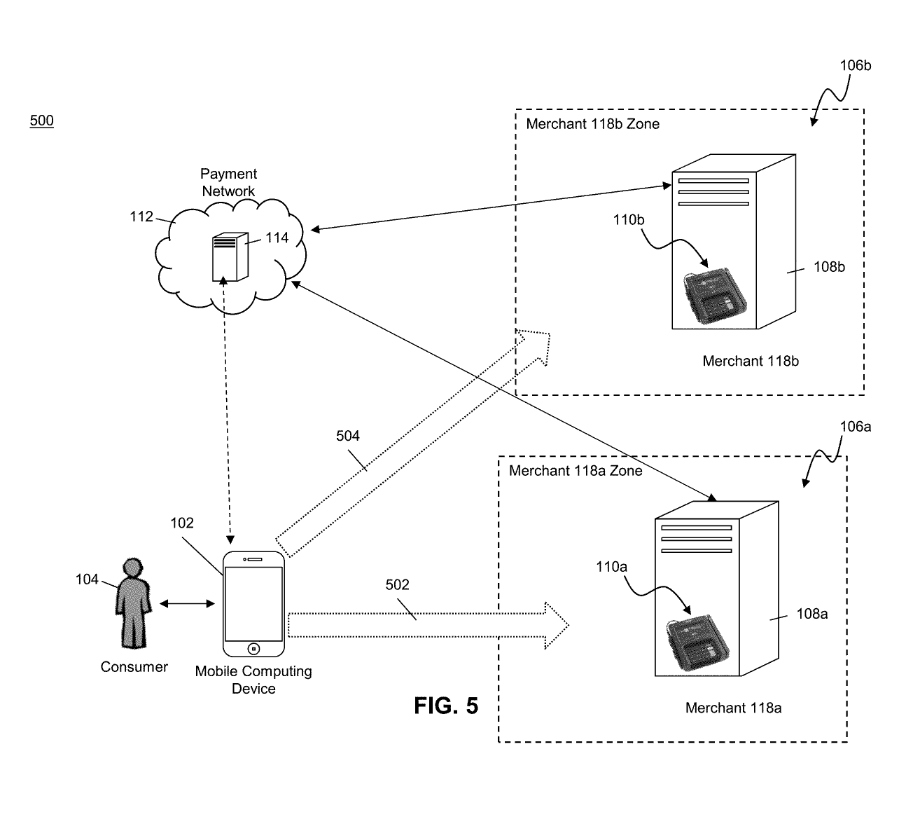

FIG. 5 illustrates an example schematic 500 illustration movement of the mobile computing device 102 through a plurality of different merchant zones 106a and 106b and the providing of the accepted forms of payment methods associated with each merchant zone 106a and 106b to the mobile computing device 102.

The mobile computing device 102 may initially be outside of the first merchant zone 106a associated with a first merchant 118a and outside of the second merchant zone 106b associated with a second merchant 118b. At this point, the merchant systems 108a and 108b and/or the payment network processing server 114 might not be transmitting information associated with payment methods to the mobile computing device 102. For example, because the mobile computing device 102 is outside of each merchant zone 106a and 106b, the merchant systems 108a and 108b and/or the payment network processing server 114 might not have determined that a geolocation associated with the mobile computing device 102 corresponds to a geolocation associated with the merchant 118a or with the merchant 118b.

The mobile computing device 102 may enter into the merchant zone 106a, which may be illustrated by the arrow marked 502. After the mobile computing device 102 enters the merchant zone 106a, the merchant systems 108a and/or the payment network processing server 114 may transmit to the mobile computing device 102 an indication of the payment methods accepted by the merchant 118a, which may cause the mobile computing device 102 to output information associated with these accepted payment methods. In some embodiments, one or more transmitters (e.g., transmitters 116a and 116b) may transmit this indication to the mobile computing device 102, such as via a beacon signal, discussed above. In some embodiments, a point of sale device 110a associated with the merchant system 108a may transmit this indication to the mobile computing device 102. In some of these embodiments, the payment network processing server 114 may transmit the indication via the point of sale device 110a and/or via the merchant system 108a to the mobile computing device 102.

In some embodiments, some or all of the accepted payment methods may be associated with one or more promotions or discounts. In some situations, the merchant system 108a and/or the payment network processing server 114 may transmit these promotions or discounts to the mobile computing device 102, such as along with an associated payment method. For example, if the merchant system 108a accepts MASTERPASS, and a promotion for MASTERPASS provides a consumer 104 with 5% off a total purchase, then this information may be transmitted to the mobile computing device 102. In some embodiments, the mobile deice 102 may output a notification of the payment method and/or the promotion, such as via a display device 408, such as illustrated in FIG. 8A, discussed below in more detail, or via an audio device 410. In some embodiments, the mobile computing device 102 may output a payment method and an associated promotion that may provide a greater discount in price than other promotions. For example, if a first promotion provides $10 off of a purchase when using MASTERPASS, and a second promotion provides $15 off a purchase when using a MasterCard credit card, then the mobile computing device 102 may output the second promotion along with the indication that the merchant 118 accepts MasterCard credit cards as a payment option.

According to some embodiments, an entity associated with the payment method may provide promotions and any terms associated with a promotion. For example, an entity associated with MASTERPASS (e.g., the entity may be MasterCard Incorporated) may provide an incentive to the merchant 118 to use MASTERPASS in payment transactions conducted at the merchant 118's physical location. For example, MasterCard Incorporated may inform the merchant 118 that the merchant 118 might not have to pay fees associated with using MASTERPASS for a first 15,000 payment transactions. To entice consumers to use MASTERPASS, the merchant 118 may associate a promotion along with use of MASTERPASS in a payment transaction (e.g., $10 off of a purchase when using MASTERPASS). In some embodiments, the merchant 118 may configure or modify promotions through a merchant portal, such as illustrated in FIGS. 7A and 7B, discussed below in more detail. In some embodiments, the entity associated with the payment method may configure or otherwise provide a promotion associated with the payment method.

In some embodiments, the merchant system 108a and/or the payment network processing server 114 may determine that the mobile computing device 102 may have previously engaged in a financial transaction with a payment method accepted by the merchant 118a. In one example, the merchant system 108a and/or the payment network processing server 114 may cause the mobile computing device 102 to prioritize the output of this previously engaged in payment method. In another example, the merchant system 108a and/or the payment network processing server 114 may identify in a merchant database 208 or 308 a second merchant (e.g., merchant 118 and/or merchant system 108b) that accepts the previously engaged in payment method. The merchant system 108a and/or the payment network processing server 114 may transmit to the mobile computing device 102 an indication that the merchant system 108b accepts the previously engaged in payment method. In some embodiments this indication may also include any promotions or discounts associated with these payment methods. According to some embodiment, the merchant system 108a and/or the payment network processing server 114 may transmit to the mobile computing device 102 an indication of the payment methods accepted by another merchant (e.g., merchant system 108b) even if the mobile computing device 102 might not have engaged in financial transaction with that particular payment method. According to some embodiments, the payment network processing server 114 may transmit the indication via the point of sale device 110a and/or via the merchant system 108a to the mobile computing device 102.

In some scenarios, the mobile computing device 102 may conduct a payment transaction, such as via one of the types of payment methods accepted by the merchant system 108a. According to some embodiments, the mobile computing device 102 may exit the merchant zone 506a.

According to some embodiments, the mobile computing device 102 may enter the merchant zone 506b, which may be illustrated by the arrow marked 504. For example, the consumer 102 may bring the mobile computing device 102 into the merchant zone 506b responsive to the mobile computing device 102 receiving information associated with a promotion associated with a payment method accepted by the merchant system 508b or point of sale device 510b, such as while the mobile computing device 102 is at or within the merchant zone 506a. After the mobile computing device 102 enters the merchant zone 106b, the merchant system 108b and/or the payment network processing server 114 may transmit to the mobile computing device 102 an indication of the payment methods accepted by the merchant 118b, which may cause the mobile computing device 102 to output information associated with these accepted payment methods. In some embodiments, the merchant system 108b and/or the payment network processing server 114 may transmit additional payment methods to the mobile computing device 102 which might not have been transmitted to the mobile device 102 while the mobile device 102 was within the merchant zone 118. For example, while the mobile computing device 102 is at or within the merchant zone 506a, the merchant system 108a and/or the payment network processing server 114 may transmit to the mobile computing device 102 types of payment methods accepted by both the merchant system 108a and merchant system 108b. Continuing with this example, after the mobile computing device 102 enters the merchant zone 506b, the merchant system 108b and/or the payment network processing server 114 may transmit to the mobile computing device 102 additional payment methods accepted by the merchant system 108b that might not have been accepted by the merchant system 108a. In some embodiments, a point of sale device 110b associated with the merchant system 108b may transmit to the mobile computing device 102 an indication of the payment methods (and associated information, such as promotions, etc.) accepted by the merchant system 108b. In some embodiments, the payment network processing server 114 may transmit the indication via the point of sale device 110b and/or via the merchant system 108b to the mobile computing device 102.

In some scenarios, the mobile computing device 102 may conduct a payment transaction, such as via one of the types of payment methods accepted by the merchant system 108b. According to some embodiments, the mobile computing device 102 may exit the merchant zone 506b.

### Providing a Notification of Accepted Payment Methods to a Mobile Device

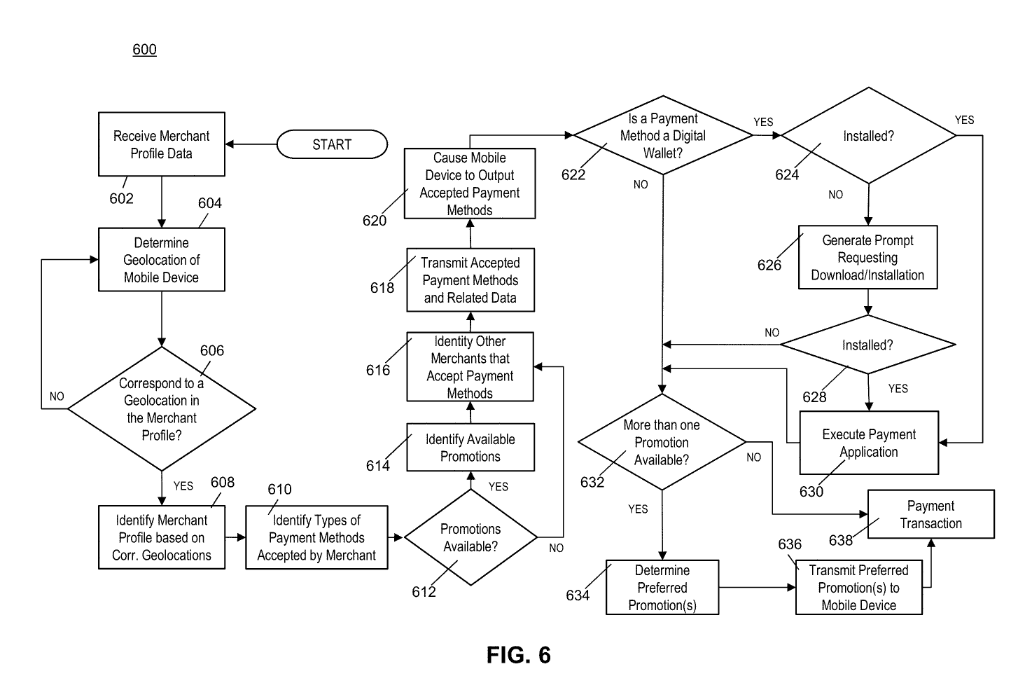

FIG. 6 is a flow diagram illustrating a process 600 of providing a notification of accepted payment methods to a mobile electronic device using the merchant system 108 and/or the payment network processing server 114 of the system 100 and illustrated in FIGS. 2 and 3.

The process 600 may begin at step 602. At step 602, the merchant system 108 and/or the payment network processing server 114 may receive and may store merchant profile data, such as in a merchant database (e.g., merchant database 208 or 308). The merchant database may include one or more merchant profiles (e.g., merchant profiles 210 or 310), where each merchant profile may include merchant data related to a respective merchant. The merchant data may include a respective merchant identifier, a respective merchant geolocation, and one or more payment methods accepted by the respective merchant as a form of payment, such as for a payment transaction with a consumer. The merchant data may also include one or more promotions and/or discounts associated with a payment method accepted by a merchant. In some embodiments, a merchant, such as merchant 118, may access a merchant portal to enter or modify information associated with one or more payment methods. For example, the merchant 118 may add or remove payment methods, and these modifications may be reflected in the merchant profile associated with the merchant 118. In another example, the merchant 118 may add or remove promotions or discounts associated with the payment methods. According to some embodiments, the merchant database may receive (e.g., from one or more point of sale devices associated with the one or more merchants) transaction data associated with one or more transactions between a respective merchant and one or more consumers, wherein the transaction data comprises a type of payment method used in each of the one or more transactions, where these types of payment methods may be identified as the accepted forms of payment for a respective merchant.

At step 604, the merchant system 108 and/or the payment network processing server 114 may determine a geolocation associated with a mobile computing device 102. For example, the mobile computing device 102 may self-report to the merchant device 108 and/or to a payment network processing server 114 the mobile computing device 102's geolocation. In another example, that the mobile computing device 102 may report that the mobile computing device 102 has passed into a defined merchant zone 106, such as via a broadcast or point-to-point transmission, or use of the geolocation detecting mechanism of a user's mobile computing device 102. In some embodiments the merchant system 108 or the point of sale device 110 may include or be associated with transmitters such as the transmitters 116a and 116b and may generate and communicate signals and data to the mobile computing device 102, where responsive to detecting and being capable of communication with the mobile computing device 102, the merchant system 108 or the point of sale device 110 may determine the mobile computing device 102's geolocation, such as whether the mobile computing device 102's geolocation is within the merchant zone 106 and at the merchant 118's geolocation. In some embodiments, the payment network processing server 114 and/or the merchant system 108 may determine the geolocation associated with the mobile computing device 102 via one or more methods apparent to persons having skill in the relevant art.

At step 606, the payment network processing server 114 and/or the merchant system 108 may determine whether the mobile computing device 102's geolocation corresponds to a geolocation in a merchant profile that is associated with a merchant and a merchant ID in the merchant database. For example, the payment network processing server 114 and/or the merchant system 108 may determine that the mobile computing device 102 is within a predetermined distance of a geolocation associated with the merchant 118. In another example, the payment network processing server 114 and/or the merchant system 108 may determine that the mobile computing device 102 is at or within a merchant zone 106 associated with the merchant 118. In some embodiments the merchant system 108 or the point of sale device 110 may include one or more transmitters such as the transmitters 116a and 116b and may generate and communicate signals and data to the mobile computing device 102, where responsive to detecting and being capable of communication with the mobile computing device 102, the merchant system 108 or the point of sale device 110 may determine that the mobile computing device 102 is within the merchant zone 106 and at the merchant's geolocation. In some embodiments, the transmitters 116a or 116b may be separate from the merchant system 108 or point of sale device 110, and may transmit information to the payment network processing server 114 and/or the merchant system 108, which may be used by the payment network processing server 114 and/or the merchant system 108 to determine whether the mobile computing device 102's geolocation corresponds to the geolocation associated with the merchant 118. If the payment network processing server 114 and/or the merchant system 108 determines that the geolocation associated with the mobile computing device 102 corresponds with a geolocation associated with a geolocation in a merchant profile, the process 600 may continue to step 608. If the payment network processing server 114 and/or the merchant system 108 does not determine that the geolocation associated with the mobile computing device 102 corresponds with a geolocation associated with a geolocation in a merchant profile, the process 600 may return to step 604.

At step 608, the payment network processing server 114 and/or the merchant system 108 may identify a merchant profile in the merchant database based on the corresponding geolocation associated with the mobile computing device 102.

At step 610, the payment network processing server 114 and/or the merchant system 108 may identify, in the identified merchant profile, the types of payment methods accepted by the related merchant. For example, the merchant 118 may accept MASTERPASS, MASTERCARD credit card payment, APPLE pay, and a pay application specific for the merchant 118. According to some embodiments, a user associated with the merchant system 108 may input or configure, via a merchant portal or application, payment method information, such as illustrated in FIGS. 7A and 7B, which will be discussed below in more detail. For example, a user associated with the merchant system 108 may select and/or remove payment methods and/or associated promotions that the merchant system 108 may accept as a form of payment in a payment transaction.

At step 612, the payment network processing server 114 and/or the merchant system 108 may determine whether any promotions associated with any of the accepted payment methods may be available in the merchant profile associated with the merchant 118 for use by the mobile computing device 102 in a financial transaction at the merchant 118, such as stored in the merchant data or otherwise determined. If there are no promotions available, the process 600 may continue to step 616. If there are promotions available, the process 600 may continue step 614.

At step 614, payment network processing server 114 and/or the merchant system 108 may identify in a respective merchant profile the available promotions for one or more of the payment methods accepted by the merchant 118. For example, the merchant profile associated with the merchant 118 (e.g., WALMART) may include the following promotions:

5% off total purchase using MASTERPASS

$5 off total purchase of $50 using MASTERPASS

10% off electronic products using APPLE pay

$15 cash back on $100 transaction using WALMART Pay Application

According to some embodiments, a user associated with the merchant 118 may configure one or more of the promotions associated with an accepted payment method. In some embodiments, an entity associated with a payment method (e.g., the entity may be APPLE for the payment method APPLE pay) may provide one or more promotions associated with the corresponding payment method, which may show up on a merchant portal. An illustrative example of a merchant portal can be found in FIG. 7B, which will be discussed below in more detail.

At step 616, the payment network processing server 114 and/or the merchant system 108 may identify one or more other merchant profiles that may include as forms of accepted payment methods the one or more of the payment methods accepted by the initial merchant 118. In some scenarios, the payment network processing server 114 and/or the merchant system 108 may determine that the mobile computing device 102 may have previously engaged in a payment transaction involving MASTERPASS, which may be accepted by the initial merchant 118. In this example, the payment network processing server 114 and/or the merchant system 108 may determine other merchant profiles that include MASTERPASS as a form of accepted payment. In some embodiments, the identified other merchant profiles may include a merchant geolocation that may correspond with the geolocation associated with the mobile computing device 102. For example, the identified other merchant profiles may include a geolocation within a predetermined distance of the determined geolocation associated with the mobile computing device 102. In some embodiments, the other merchant profiles may be identified based on the types of goods or items offered for sale by or services provided by these other merchants. For example, the identified other merchant profiles may be associated with merchants that offer for sale goods different from the goods offered for sale by the initial merchant 118, or may be associated with merchants that offer for sale goods the same as or similar to the goods offered for sale by the initial merchant 118.

At step 618, the payment network processing server 114 and/or the merchant system 108 may transmit to the mobile computing device 102 an indication of the payment methods accepted by the merchant 118. According to some embodiments, the payment network processing server 114 and/or the merchant system 108 may transmit an indication of any data related to the payment methods accepted by the merchant 118 (e.g., any associated promotions, other merchant information, etc.)

At step 620, the payment network processing server 114 and/or the merchant system 108 may cause the mobile computing device 102 to output information associated with the one or more payment methods accepted by the merchant 118. For example, the payment network processing server 114 and/or the merchant system 108 may cause, via the indication transmitted at step 618, the mobile computing device 102 to generate a user interface or display of the one or more payment methods accepted by the merchant 118. For example, the merchant 118 may be WALMART and may accept MASTERPASS, MASTERCARD credit card payment, APPLE pay, and a WALMART pay application as forms of payment methods. In this example, the payment network processing server 114 and/or the merchant system 108 may cause the mobile computing device 102 to generate a display showing that this WALMART merchant accepts these types of payment methods. An illustrative example is shown in FIG. 8A, which will be discussed below in more detail.

According to some aspects, the payment network processing server 114 and/or the merchant system 108 may cause (e.g., via the indication transmitted at step 618) the mobile computing device 102 to output any data related to the payment methods accepted by the merchant 118 (e.g., any associated promotions, other merchant information, etc.). For example, the payment network processing server 114 and/or the merchant system 108 may cause the mobile computing device 102 to generate a user interface or display of the available promotions associated with the payment methods accepted by the merchant 118. For example, the promotions may include:

5% off total purchase using MASTERPASS

$5 off total purchase of $50 using MASTERPASS

10% off electronic products using APPLE pay

$15 cash back on $100 transaction using WALMART Pay Application

An illustrative example is shown in FIG. 8A, which will be discussed below in more detail.

According to some aspects, the payment network processing server 114 and/or the merchant system 108 may cause the mobile computing device 102 to output a prioritized list of accepted payment methods. An illustrative example may be shown in FIG. 8A (discussed below in more detail), where the MASTERPASS payment method may have top priority, the MasterCard Credit Card may have second priority, APPLE Pay may have third priority, and the WALMART Pay Application may have fourth priority. In some embodiments, the priority may be based on user preferences. For example, the user may prefer to use MASTERPASS over other payment methods accepted by the merchant 118, and may configure the mobile computing device 102 accordingly. In such an example, the MASTERPASS payment method may be prioritized over the other payment methods accepted by the merchant 118.

In some embodiments, the payment methods may be prioritized in accordance with a top-of-wallet payment preference or a list of prioritized payment methods (e.g., customizable by the user 104). For example, a user 104 may order preferred payment methods on the mobile computing device 102 based on a priority, such as ordering the payment method the user 104 may desire to use in payment transactions as having top priority over other payment methods. In one example, the payment network processing server 114 and/or the merchant system 108 may cause the mobile computing device 102 to re-order the top-of-wallet prioritization order on a mobile computing device 102 based on the payment methods accepted by the merchant 118, and may cause the mobile computing device 102 to output information associated with the re-ordered top-of-wallet list of accepted payment methods. For example, the mobile computing device 102 may be configured to prioritize ALI Pay over Apple Pay, and Apple Pay over WALMART Pay. If the merchant 118 does not accept ALI pay but accepts Apple Pay and WALMART Pay, the indication sent at step 618 may cause the mobile computing device 102 to prioritize Apple Pay as the top prioritized payment method and WALMART pay as a less prioritized payment method, and to output information associated with this prioritization (e.g., adjusting a display of the prioritized list of payment methods based on the user's geolocation related to a merchant's geolocation).

According to some aspects, a top prioritized payment method for a user 104 and/or associated mobile computing device 102 may be a payment method (e.g., digital wallet, credit card, etc.) that may receive a large share (e.g., largest share, majority share, large percentage, etc.) of the user 104's spending (e.g., payment transactions). In one example, if the user uses the MASTERPASS payment method in 90% of merchant payment transactions, then the MASTERPASS may be prioritized over other payment methods. In some embodiments, information associated with the top prioritized payment method may be the only payment method information output by the mobile. In one example, if MASTERPASS if the first prioritized payment method in the user 104's top-of-wallet on the mobile computing device 102, the mobile computing device may output information associated with the MASTERPASS payment method instead of other payment methods, some of which may be in the user 104's top-of-wallet, but may have a lower prioritization than the MASTERPASS payment method. An example may be shown in FIG. 8B, which will be discussed below in more detail.

According to some aspects, the payment network processing server 114 and/or the merchant system 108 may cause the mobile computing device 102 to generate a user interface or display of other merchants that may accept some or all of the types of payment methods accepted by the initial merchant 118. For example, a second WALMART store, a SAFEWAY, a STARBUCKS, and a BURGER KING may all accept MASTERPASS as a method of payment. In this example, the payment network processing server 114 and/or the merchant system 108 may cause the mobile computing device 102 to generate a display indicating this information. An illustrative example is shown in FIG. 8C, which will be discussed below in more detail.

According to some aspects, the payment network processing server 114 and/or the merchant system 108 may cause the mobile computing device 102 to output information associated one or more payment methods accepted by a merchant 118 based on product data (e.g., stock keeping unit (SKU) data) corresponding to products offered for sale by the merchant 118. For example, a user may wish to use a particular type of payment method for certain types of products. In one example, the user may wish to use a credit card offering 5% cash back for gasoline purchases when the user is at a gas station merchant. In such a case, the payment network processing server 114 and/or the merchant system 108 may cause the mobile computing device 102 to output information associated with this particular credit card (e.g., display and/or suggest using that particular credit card and/or any associated information) when the user 102 arrives at that gas station merchant. In another example, the user 102 may wish to use APPLE pay to purchase APPLE products, such as to receive APPLE incentives or rewards. In such a case, the payment network processing server 114 and/or the merchant system 108 may cause the mobile computing device 102 to output information associated with APPLE pay (e.g., display and/or suggest using APPLE pay and/or any associated information) responsive to determining that the merchant 118 sells APPLE products. In another scenario, the user 104 may scan one or more APPLE products with the mobile computing device 104, and the payment network processing server 114 and/or the merchant system 108 may cause the mobile computing device 102 to output information associated with APPLE pay (e.g., display and/or suggest using APPLE pay and/or any associated information) responsive to receiving this scanned information (e.g., product identifier, SKU data, etc.).

According to some aspects, the payment network processing server 114 and/or the merchant system 108 may cause the mobile computing device 102 to generate one or more audible sounds associated with the accepted payment methods, such as stating or uttering (via a speaker) the types of accepted payment methods, any associated promotions, and/or a merchant's name or brand (or any related data).

At step 622, the payment network processing server 114 and/or the merchant system 108 may determine whether a payment method accepted by the merchant 118 is a digital wallet application payment method, such as MASTERPASS, ALIPAY, APPLE pay, etc. If the payment network processing server 114 and/or the merchant system 108 determines that an accepted payment method is not a digital wallet, the process 600 may continue to step 632. If the payment network processing server 114 and/or the merchant system 108 determines that an accepted payment method is a digital wallet application payment method, the process 600 may continue to step 624.

At step 624, the payment network processing server 114 and/or the merchant system 108 may determine whether the accepted digital wallet application payment method is installed on the mobile computing device 102 (or otherwise associated with the mobile computing device 102, such as through the cloud), such as through methods and protocols as will be apparent to persons having skill in the relevant art. If the payment network processing server 114 and/or the merchant system 108 determines that the accepted digital wallet application payment method is installed on the mobile computing device 102, the process 600 may continue to step 630. If the payment network processing server 114 and/or the merchant system 108 determines that the accepted digital wallet application payment method is not installed on the mobile computing device 102, the process 600 may continue to step 626.

At step 626, the payment network processing server 114 and/or the merchant system 108 may cause (e.g., via one or more transmitted signals) the mobile computing device 102 to generate a prompt (or otherwise a notification) requesting installation or the downloading of one or more applications associated with the digital wallet payment method. For example, if the mobile computing device 102 did not have APPLE pay installed, then at step 626, the mobile computing device 102 may generate and/or display a prompt requesting the consumer 102 (or other user) to download, install, and/or register an application associated with the APPLE pay payment method. In some embodiments, the payment network processing server 114 and/or the merchant system 108 may automatically cause the mobile computing device 102 to download, install, and/or register an application associated with the accepted digital wallet payment method.

At step 628, the payment network processing server 114 and/or the merchant system 108 may determine whether the digital wallet payment application was downloaded, installed, and/or registered. If the digital wallet payment application was not downloaded, installed, and/or registered (or otherwise configured on the mobile device 102 to functionally operate as a payment method), the process 600 may continue to step 632. If the digital wallet payment application was downloaded, installed, and/or registered (or otherwise configured on the mobile device 102 to functionally operate as a payment method), the process 600 may continue to step 630.

At step 630, the payment network processing server 114 and/or the merchant system 108 may cause (e.g., via one or more transmitted signals) the mobile computing device 102 to execute the accepted digital wallet payment application. In some embodiments, the payment network processing server 114 and/or the merchant system 108 may cause (e.g., via one or more transmitted signals) the mobile computing device 102 to display data related to the accepted digital wallet payment application, such as discussed above (e.g., promotions, other merchant that accept that type of payment method, etc.).

At step 632, the payment network processing server 114 and/or the merchant system 108 may determine whether there is more than one promotion available. For example, the payment network processing server 114 and/or the merchant system 108 may determine that there may be more than one promotion available when the available promotions include at least one promotion associated with more than one payment method, for example:

5% off total purchase using MASTERPASS

$5 off total purchase of $50 using MASTERPASS

10% off electronic products using APPLE pay

$15 cash back on $100 transaction using WALMART Pay Application

According to some aspects, the payment network processing server 114 and/or the merchant system 108 may determine that there may be more than one promotion available when the available promotions include more than one promotion associated with a particular payment method. For example, there may be two promotions available for MASTERPASS (such as shown above).

If the payment network processing server 114 and/or the merchant system 108 determines that there is more than one promotion available, the process 600 may continue to step 638. If the payment network processing server 114 and/or the merchant system 108 determines that there is more than one promotion available, the process 600 may continue to step 634.

At step 634, the payment network processing server 114 and/or the merchant system 108 may determine one or more preferred promotions. For example, the preferred promotion may be a promotion associated with a type of payment method the mobile computing device 102 typically or frequently uses in payment transactions. In another example, the preferred promotion may be promotion that provides a greater promotional value over another promotion. For example, the preferred promotion may provide a greater discount in cost for a user, such as a discount providing $15 off a payment transaction with a particular merchant using a first payment method as opposed to a discount providing $10 off a payment transaction with the particular merchant using a second payment method. In another example, the preferred promotion may provide a greater discount in cost for a specific combination of items offered for sale by a merchant. For example, a consumer 104 may input (e.g., via scanning product identifiers, a shopping application, manual input, etc.) into the mobile computing device 102 transaction data associated with a specific combination of one or more products (e.g., with corresponding product identifiers) offered for sale at the merchant 118, including a price for the products. The payment network processing server 114 and/or the merchant system 108 may store product data (e.g., stock keeping unit (SKU) level data) and/or prices for products offered for sale by the merchant 118, and the payment network processing server 114 and/or the merchant system 108 may determine the price of goods based on corresponding the product data and/or prices. For example, a consumer 104 may input (e.g., via scanning product identifiers, a shopping application, manual input, etc.) into the mobile computing device 102 transaction data associated with a specific combination of one or more products (with corresponding product identifiers) offered for sale at the merchant 118, including a price for the products. The payment network processing server 114 and/or the merchant system 108 may store product data (e.g., stock keeping unit (SKU) level data) and/or prices for products offered for sale by the merchant 118, and the payment network processing server 114 and/or the merchant system 108 may determine the price of goods based on corresponding the product data and/or prices.

In one example, the total cost of this specific combination may be $500. In this example, a promotion providing 5% off of a total purchase (e.g., $25 here) may provide a greater discount in cost than a promotion providing $15 cash back. In another example, the total costs of the specific combination may be $100. In this example, a promotion providing $15 cash back may provide a greater discount in cost than a promotion providing 5% off a total purchase (e.g., $5 here). In another example, the specific combination of items may include two of a same type of item, and each item may costs $50. In this example, a promotion providing buy one item and get a same item free may provide a greater discount in cost (e.g., $50 here) compared to a promotion providing $15 cash back. In another example, a preferred promotion may be based on a prioritized list of payment methods, such as a top-of-wallet order for a user 102 and the associated mobile computing device 104 (as discussed above). For example, the preferred promotion may be a promotion associated with a higher prioritized payment method (e.g., the highest prioritized payment method configured on the mobile computing device 104). In some embodiments, more than one preferred promotion may be determined, such as two or three (or more) promotions that provide the greatest discount in cost to a user. In some embodiments, a preferred promotion may be determined for other merchants that may accept a type of payment method accepted by the merchant 118.

At step 636, the payment network processing server 114 and/or the merchant system 108 may transmit an indication of the preferred promotion(s) to the mobile computing device 102. According to some aspects, the indication may cause the mobile device to output (e.g., via a display and/or an audio device) information associated with the preferred promotion(s). An illustrative example is shown in FIGS. 8A and 8B, which will be discussed below in more detail.

At step 638, the mobile computing device 102 may initiate a payment transaction with the merchant system 108 and/or the payment network processing server 114. For example, the consumer 104 may use the mobile computing device 102 to purchase items offered for sale by the merchant 118 at the merchant location with one of the payment methods accepted by the merchant system 108. In another example, the consumer may use a credit card or cash instead of using the mobile computing device 102. In another example, the consumer may use a combination of electronic and non-electronic payment methods. According to some aspects, the consumer 104 might decide to not initiate a payment transaction.

According to some aspects, one or more of the steps of the process 600 may include additional details, be combined with other steps, be omitted, be repeated, and/or be performed in any order. According to some aspects, the process 600 may begin at any step and/or end after any step.

### Merchant Portal

FIGS. 7A and 7B illustrate exemplary graphical merchant portal interfaces, which may be displayed on a display of a computing device, such as the computer system 1000 illustrated in FIG. 10 and discussed in more detail below.

FIG. 7A is an illustration of a merchant portal display 702 for editing and/or configuring information associated with the payment methods accepted by a particular merchant. The display 702 may include a merchant identifier 704, which may identify the particular merchant. For example, the merchant identifier may be ID 1112, which may correspond to the merchant 118. The display 702 may include an “Accepted Payment Methods” section 708, which may identify the payment methods accepted by the merchant 118. The display 702 may include an “Add a Payment Method” section 710, which may identify the payment methods that can be added as payment methods accepted by the merchant 118. According to some aspects, a user accessing the merchant portal may select one of the listed payment methods using, for example, a selector 706. For example, one of the accepted payment methods may be selected by selecting the selector 706 corresponding to that accepted payment method, and then in some instances, may be removed as a type of payment method accepted by the merchant 118 after a user select the “Remove/Add” button 712. According to some aspects, a payment method from section 710 may be added as an accepted payment method in a similar manner. In some embodiments, a user of the merchant portal display 702 may configure or edit additional information, such as a time limit or timeframe associated with a particular payment method.

FIG. 7B is an illustration of a merchant portal display 714 for editing and/or configuring information associated with promotions associated with payment methods. The display 714 may include a merchant identifier 704. The display 714 may also include an “Available Promotions” section 716, which may identify the promotions that are available for consumers to use in a payment transaction with the merchant 118. The display 714 may also include a “Non-Selected Promotions” section 718, which may identify the promotions that might not be available for consumers to use in a payment transaction with the merchant 118, but may optionally be selected and/or added to the “Available Promotions” section 716. According to some aspects, a promotion may be added or removed from either section 716 or 718 using the selector 706 and/or the button 712, as discussed above. In some embodiments, a user of the merchant portal display 14 may configure or edit additional information, such as a time limit or timeframe associated with a particular promotion.

### Mobile Computing Device Interface

FIGS. 8A, 8B, and 8C illustrate exemplary graphical user interfaces, which may be displayed on a display of the mobile computing device 102.

FIG. 8A is an illustration of a user interface 802, which may be generated by the mobile computing device 102, such as responsive to receiving information from the merchant system 108, the payment network processing server 114, the point of sale device 110, and/or a transmitter 116a or 116b. The interface 802 may show information associated with the payment methods accepted by a particular merchant 118. The interface 802 may include a merchant identifier 804, which may identify a name or brand associated with the merchant 118 (e.g., WALMART here). The interface 802 may include a section 806, which may show the types of payment methods accepted by the merchant 118. In some embodiments, the section 806 may be a prioritized list of payment methods that are accepted by the user and prioritized based on a user's top-of-wallet preferences. For example, the user 104 may configure the mobile computing device 102 to have MasterPass as the preferred payment method over the other types of payment methods. In another example, the user 104 may configure the mobile computing device 102 to have a payment method that might not be accepted by the merchant 118 (e.g., ALI pay) as the most preferred payment method (e.g., at the top of the top-of-wallet list of payment methods). In such an example, the prioritized list on the mobile computing device 102 may be adjusted based on the types of payment methods accepted by the merchant 118. For example, the user 102's most preferred payment method that is accepted by the merchant 118 may be ordered first in a list of prioritized payment methods. The interface 802 may include a section 808, which may show some or all of the promotions currently being offered by the merchant 118 and associated with a particular payment method accepted by the merchant 118. According to some aspects, a preferred promotion (described above) may also be indicated on the interface 802 in some manner. For example, the promotion “5% off total purchase using MasterPass” may be a preferred promotion and may be indicated with some designation, such as “****” or other type of designation.

FIG. 8B is an illustration of a user interface 810, which may be generated by the mobile computing device 102, such as responsive to receiving information from the merchant system 108, the payment network processing server 114, the point of sale device 110, and/or a transmitter 116a or 116b. According to some aspects, the interface 810 may show information associated with one or more preferred promotions associated with one or more of the payment methods accepted by a particular merchant 118. The interface 810 may include a merchant identifier 804. The interface 810 may include a preferred promotions section 812, which may show the preferred promotions. The interface 810 may include a “Notification” section 814, which may provide information associated with a preferred promotion, such as information explaining why a preferred promotion was chosen as a preferred promotion. In some aspects, the interface 810 may display a top prioritized payment method, such as in accordance with top-of-wallet prioritized list of payment methods (as discussed above).

FIG. 8C is an illustration of the user interface 802. The interface 802 may include the merchant identifier 804 and the section 806, which may show the types of payment methods accepted by the merchant 118. The interface 802 may also include a section 816, which may identify other merchants (e.g., in addition to the merchant 118 identified by merchant identifier 804) that may accept one of the payment methods accepted by the merchant 118. For example, the merchant 118 may accept MASTERPASS as a method of payment (as shown in FIG. 8C), and the section 816 may show other merchants accepting MASTERPASS as a method of payment. According to some aspects, the section 816 may also show other information associated with these other merchants, such as the distance away from the mobile computing device 102. In some embodiments, the user interface 802 may show other merchants that may accept payment methods that might not be accepted by the merchant 118. For example, the user interface 802 may show merchants accepting ALI pay, which may not be accepted by the merchant 118. In another example, the user interface 802 may show merchants accepting a payment method preferred by the user 102 (e.g., in accordance with a top-of-wallet list), such as when the merchant 118 might not accept a payment method preferred by the user 104. Exemplary Method for Providing Payment Method Notifications to a Mobile Device

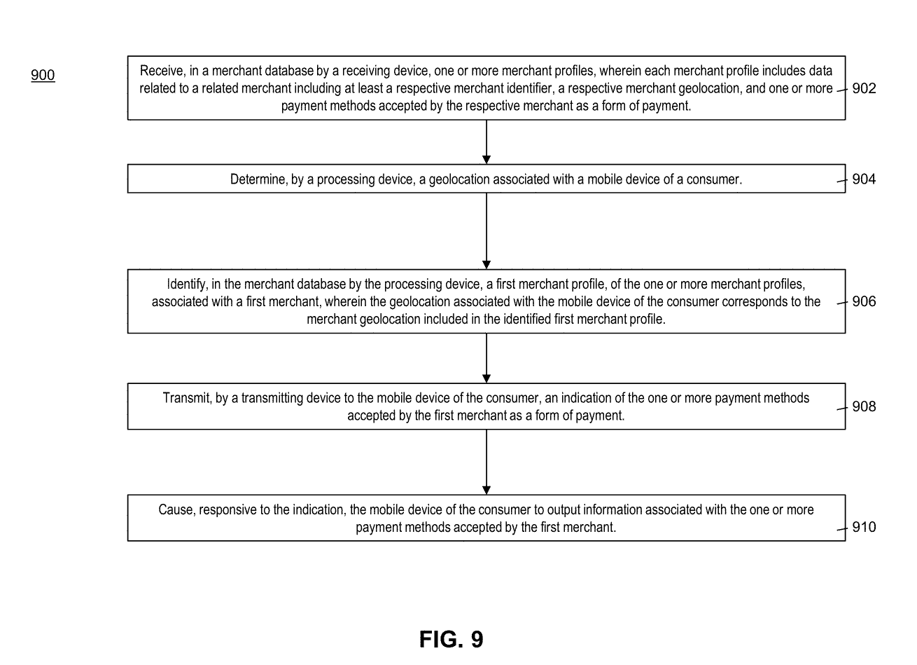

FIG. 9 is a flowchart illustrating an exemplary method 900 for providing payment method notifications to a mobile device in accordance with exemplary embodiments.

In step 902, a receiving device (e.g., receiving unit 202 or 302) may receive in a merchant database (e.g., merchant database 208 or 308) one or more merchant profiles (e.g., merchant profiles 210 or 310), and each of the merchant profiles may include data related to a related merchant. The data related to the related merchant may include at least a respective merchant identifier, a respective merchant geolocation, and one or more payment methods accepted by the respective merchant as a form of payment.

In step 904, a processing device (e.g., processing unit 204 or 304) may determine a geolocation associated with a mobile device (e.g., the mobile computing device 102) associated with a consumer (e.g., the consumer 104).

In step 906, the processing device may identify in the merchant database a first merchant profile, of the one or more merchant profiles, associated with a first merchant (e.g., merchant 118), where the geolocation associated with the mobile device of the consumer may correspond to the merchant geolocation included in the identified first merchant profile.

In step 908, a transmitting device (e.g. the transmitting unit 206 or 306) may transmit to the mobile device of the consumer, an indication of the one or more payment methods accepted by the first merchant as a form of payment.

In step 910, responsive to the indication, the mobile device of the consumer is caused to output information associated with the one or more payment methods accepted by the first merchant.

In some embodiments, the receiving device is further configured to receive information identifying at least one promotion associated with (i) the first merchant and (ii) the one of the one or more payment methods accepted by the first merchant, and the transmitting device is further configured to transmit the indication by transmitting the information identifying the at least one promotion.

In some embodiments, the one or more payments accepted by the first merchant as a form of payment comprises a first payment method and a second payment method, the at least one promotion comprises a first promotion associated with the first payment method and a second promotion associated with the second payment methods, and the processing device is further configured to: determine whether the first promotion or the second promotion provides a greater promotional value; responsive to the first promotion providing a greater promotional value, cause the mobile device of the consumer to output information associated with the first promotion and not the second promotion; and responsive to the second promotion providing a greater promotional value, cause the mobile device of the consumer to output information associated with the second promotion and not the first promotion.

In some embodiments, the receiving device is further configured to receive, from the mobile device associated with the consumer, transaction data associated with a specific combination of one or more products offered for sale at the merchant geolocation included in the identified first merchant profile, and the processing device is further configured to determine whether the first promotion or the second promotion provides the greater promotion value by determining whether the first promotion or the second promotion provides a greater discount in cost for the received transaction data associated with the specific combination of one or more products offered for sale at the merchant geolocation included in the identified first merchant profile.

In some embodiments, the receiving device is further configured to receive from one or more point of sale devices associated with the one or more merchants, transaction data associated with one or more transactions between a respective one of the merchants and one or more consumers, wherein the transaction data comprises a type of payment method used in each of the one or more transactions; and the processing device is further configured to: identify from the transaction data, the one or more payment methods used in the one or more transactions involving each respective merchant; and store, in the merchant database, the identified one or more payment methods.

In some embodiments, the processing device is further configured to: determine that the mobile device of the consumer has previously engaged in a transaction with a first one of the one or more payment methods accepted by the first merchant; and identify, in the merchant database, a second merchant profile that includes the first one of the one or more payment methods accepted by the first merchant; and the transmitting device is further configured to transmit, to the mobile device of the consumer, an indication that the second merchant accepts as a form of payment the first one of the one or more payment methods accepted by the first merchant.

In some embodiments, a geolocation associated with the second merchant corresponds to the geolocation of the mobile device associated with the consumer.

In some embodiments, the second merchant offers for sale goods different from goods offered for sale by the first merchant.

In some embodiments, the processing device is further configured to cause, responsive to the indication that the second merchant accepts as a form of payment the first one of the one or more payment methods accepted by the first merchant, the mobile device of the consumer to output a promotion associated with the second merchant and the first one of the payment methods accepted by the first merchant.

In some embodiments, the processing device is further configured to cause the mobile device of the consumer to output information associated with the one or more payment methods accepted by the first merchant by causing the mobile device to generate a display of the one or more payment methods accepted by the first merchant.

In some embodiments, the processing device is further configured to cause the mobile device of the consumer to output information associated with the one or more payment methods accepted by the first merchant by causing the mobile device to generate an audible sound associated with the one or more payment methods accepted by the first merchant.

In some embodiments, the one or more payment methods accepted by the first merchant comprise a digital wallet payment method.

In some embodiments, the processing device is further configured to: responsive to an application associated with the digital wallet payment method being installed on the mobile device associated with the consumer, cause the mobile device associated with the consumer to execute the application associated with the digital wallet payment method; and responsive to an application associated with the digital wallet payment method not being installed on the mobile device associated with the consumer, cause the mobile device associated with the consumer to generate a prompt requesting installation of one or more applications associated with the digital wallet payment method.

In some embodiments, the transmitting device is further configured to transmit the indication of the one or more payment methods accepted by the first merchant as a form of payment by transmitting a beacon to the mobile device associated with the consumer via near field communication, via Bluetooth communication, via Bluetooth low energy (BLE) communication, or via a wireless local area network communication.

In some embodiments, the processing device is further configured to determine the geolocation associated with the mobile device of the consumer by receiving, via the receiving device, location data associated with the mobile device of the consumer from one or more transmitters located at the merchant geolocation included in the identified first merchant profile.

In some embodiments, the processing device is further configured to cause the mobile device of the consumer to output information associated with the one or more payment methods accepted by the first merchant by causing the mobile device of the consumer to output a prioritized list of payment methods accepted by the first merchant.

In some embodiments, the processing device is further configured to receive product data associated with a plurality of products offered for sale by the first merchant, wherein the data comprises a product identifier and receive, from the mobile device of the consumer, a set of one or more product identifiers each associated with a product offered for sale by the first merchant, and the processing device is further configured to cause the mobile device of the consumer to output information associated with the one or more payment methods accepted by the first merchant based on the product data corresponding to the products associated with the received set of one or more product identifiers.

### Computer System Architecture

FIG. 10 illustrates a computer system 1000 in which embodiments of the present disclosure, or portions thereof, may be implemented as computer-readable code. For example, the mobile computing device 102, the merchant system 108, the point of sale device 110, and the payment network processing server 114 of FIG. 1 may be implemented as the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods and processes of FIGS. 5-9

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device specifically configured to perform the functions discussed herein. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods and processes illustrated by FIGS. 5-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

The processor device 1004 may comprise one or more modules or engines configured to perform the functions of the computer system 1000. Each of the modules or engines may be implemented using hardware and, in some instances, may also utilize software, such as corresponding to program code and/or programs stored in the main memory 1008 or secondary memory 1010. In such instances, program code may be compiled by the processor device 1004 (e.g., by a compiling module or engine) prior to execution by the hardware of the computer system 1000. For example, the program code may be source code written in a programming language that is translated into a lower level language, such as assembly language or machine code, for execution by the processor device 1004 and/or any additional hardware components of the computer system 1000. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 1000 to perform the functions disclosed herein. It will be apparent to persons having skill in the relevant art that such processes result in the computer system 1000 being a specially configured computer system 1000 uniquely programmed to perform the functions discussed above.

Techniques consistent with the present disclosure provide, among other features, systems and methods for managing account savings via authorization holds. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing accepted forms of payment to a mobile device at a merchant location, comprising:
receiving, in a merchant database by a receiving device, one or more merchant profiles, wherein each merchant profile includes data related to a related merchant including at least a respective merchant identifier, a respective merchant geolocation, and one or more payment methods accepted by the respective merchant as a form of payment;
determining, by a processing device, a geolocation associated with a mobile device of a consumer;
identifying, in the merchant database by the processing device, a first merchant profile, of the one or more merchant profiles, associated with a first merchant, wherein the geolocation associated with the mobile device of the consumer corresponds to the merchant geolocation included in the identified first merchant profile;
transmitting, by a transmitting device to the mobile device of the consumer, an indication of the one or more payment methods accepted by the first merchant as a form of payment; and
causing, responsive to the indication, the mobile device of the consumer to output information associated with the one or more payment methods accepted by the first merchant.

2. The method of claim 1, further comprising:
receiving, by the receiving device, information identifying at least one promotion associated with (i) the first merchant and (ii) the one of the one or more payment methods accepted by the first merchant,
wherein transmitting the indication comprises transmitting the information identifying the at least one promotion.

3. The method of claim 2, wherein:
the one or more payments accepted by the first merchant as a form of payment comprises a first payment method and a second payment method,
the at least one promotion comprises a first promotion associated with the first payment method and a second promotion associated with the second payment methods, and
the method further comprises:
determining whether the first promotion or the second promotion provides a greater promotional value;
responsive to the first promotion providing a greater promotional value, causing the mobile device of the consumer to output information associated with the first promotion and not the second promotion; and
responsive to the second promotion providing a greater promotional value, causing the mobile device of the consumer to output information associated with the second promotion and not the first promotion.

4. The method of claim 3, further comprising:
receiving, by the receiving device from the mobile device associated with the consumer, transaction data associated with a specific combination of one or more products offered for sale at the merchant geolocation included in the identified first merchant profile, wherein
determining whether the first promotion or the second promotion provides the greater promotion value comprises determining whether the first promotion or the second promotion provides a greater discount in cost for the received transaction data associated with the specific combination of one or more products offered for sale at the merchant geolocation included in the identified first merchant profile.

5. The method of claim 1, wherein receiving the one or more merchant profiles comprises:
receiving, from one or more point of sale devices associated with the one or more merchants, transaction data associated with one or more transactions between a respective one of the merchants and one or more consumers, wherein the transaction data comprises a type of payment method used in each of the one or more transactions;
identifying, from the transaction data, the one or more payment methods used in the one or more transactions involving each respective merchant; and
storing, in the merchant database, the identified one or more payment methods.

6. The method of claim 1, further comprising:
determining that the mobile device of the consumer has previously engaged in a transaction with a first one of the one or more payment methods accepted by the first merchant;
identifying, in the merchant database, a second merchant profile that includes the first one of the one or more payment methods accepted by the first merchant; and
transmitting, to the mobile device of the consumer, an indication that the second merchant accepts as a form of payment the first one of the one or more payment methods accepted by the first merchant.

7. The method of claim 6, wherein a geolocation associated with the second merchant corresponds to the geolocation of the mobile device associated with the consumer.

8. The method of claim 6, wherein the second merchant offers for sale goods different from goods offered for sale by the first merchant.

9. The method of claim 6, further comprising causing, responsive to the indication that the second merchant accepts as a form of payment the first one of the one or more payment methods accepted by the first merchant, the mobile device of the consumer to output a promotion associated with the second merchant and the first one of the payment methods accepted by the first merchant.

10. The method of claim 1, wherein causing the mobile device of the consumer to output information associated with the one or more payment methods accepted by the first merchant comprises causing the mobile device to generate a display of the one or more payment methods accepted by the first merchant.

11. The method of claim 1, wherein causing the mobile device of the consumer to output information associated with the one or more payment methods accepted by the first merchant comprises causing the mobile device to generate an audible sound associated with the one or more payment methods accepted by the first merchant.

12. The method of claim 1, wherein the one or more payment methods accepted by the first merchant comprise a digital wallet payment method.

13. The method of claim 12, further comprising:
responsive to an application associated with the digital wallet payment method being installed on the mobile device associated with the consumer, causing the mobile device associated with the consumer to execute the application associated with the digital wallet payment method; and
responsive to an application associated with the digital wallet payment method not being installed on the mobile device associated with the consumer, causing the mobile device associated with the consumer to generate a prompt requesting installation of one or more applications associated with the digital wallet payment method.

14. The method of claim 1, wherein causing the mobile device of the consumer to output information associated with the one or more payment methods accepted by the first merchant comprises causing the mobile device of the consumer to output a prioritized list of payment methods accepted by the first merchant.

15. The method of claim 1, further comprising:
receiving, by the receiving device, product data associated with a plurality of products offered for sale by the first merchant; and
causing the mobile device of the consumer to output information associated with the one or more payment methods accepted by the first merchant based on the received product data.

16. A system for providing accepted forms of payment to a mobile device at a merchant location, comprising:
a receiving device configured to receive, in a merchant database, one or more merchant profiles, wherein each merchant profile includes data related to a related merchant including at least a respective merchant identifier, a respective merchant geolocation, and one or more payment methods accepted by the respective merchant as a form of payment;
a processing device configured to:
determine a geolocation associated with a mobile device of a consumer; and
identify, in the merchant database, a first merchant profile, of the one or more merchant profiles, associated with a first merchant, wherein the geolocation associated with the mobile device of the consumer corresponds to the merchant geolocation included in the identified first merchant profile; and
a transmitting device configured to transmit, to the mobile device of the consumer, an indication of the one or more payment methods accepted by the first merchant as a form of payment,
wherein the processing device is further configured to cause, responsive to the indication, the mobile device of the consumer to output information associated with the one or more payment methods accepted by the first merchant.

17. The system of claim 16, wherein:
the receiving device is further configured to receive information identifying at least one promotion associated with (i) the first merchant and (ii) the one of the one or more payment methods accepted by the first merchant, and
the transmitting device is further configured to transmit the indication by transmitting the information identifying the at least one promotion.

18. The system of claim 17, wherein:
the one or more payments accepted by the first merchant as a form of payment comprises a first payment method and a second payment method,
the at least one promotion comprises a first promotion associated with the first payment method and a second promotion associated with the second payment methods, and
the processing device is further configured to:
determine whether the first promotion or the second promotion provides a greater promotional value;
responsive to the first promotion providing a greater promotional value, cause the mobile device of the consumer to output information associated with the first promotion and not the second promotion; and
responsive to the second promotion providing a greater promotional value, cause the mobile device of the consumer to output information associated with the second promotion and not the first promotion.

19. The system of claim 18, wherein
the receiving device is further configured to receive, from the mobile device associated with the consumer, transaction data associated with a specific combination of one or more products offered for sale at the merchant geolocation included in the identified first merchant profile, and
the processing device is further configured to determine whether the first promotion or the second promotion provides the greater promotion value by determining whether the first promotion or the second promotion provides a greater discount in cost for the received transaction data associated with the specific combination of one or more products offered for sale at the merchant geolocation included in the identified first merchant profile.

20. The system of claim 16, wherein:
the receiving device is further configured to receive from one or more point of sale devices associated with the one or more merchants, transaction data associated with one or more transactions between a respective one of the merchants and one or more consumers, wherein the transaction data comprises a type of payment method used in each of the one or more transactions; and
the processing device is further configured to:
identify from the transaction data, the one or more payment methods used in the one or more transactions involving each respective merchant; and
store, in the merchant database, the identified one or more payment methods.

21. The system of claim 16, wherein:
the processing device is further configured to:
determine that the mobile device of the consumer has previously engaged in a transaction with a first one of the one or more payment methods accepted by the first merchant; and
identify, in the merchant database, a second merchant profile that includes the first one of the one or more payment methods accepted by the first merchant; and
the transmitting device is further configured to transmit, to the mobile device of the consumer, an indication that the second merchant accepts as a form of payment the first one of the one or more payment methods accepted by the first merchant.

22. The system of claim 21, wherein a geolocation associated with the second merchant corresponds to the geolocation of the mobile device associated with the consumer.

23. The system of claim 21, wherein the second merchant offers for sale goods different from goods offered for sale by the first merchant.

24. The system of claim 21, wherein the processing device is further configured to cause, responsive to the indication that the second merchant accepts as a form of payment the first one of the one or more payment methods accepted by the first merchant, the mobile device of the consumer to output a promotion associated with the second merchant and the first one of the payment methods accepted by the first merchant.

25. The system of claim 16, wherein the processing device is further configured to cause the mobile device of the consumer to output information associated with the one or more payment methods accepted by the first merchant by causing the mobile device to generate a display of the one or more payment methods accepted by the first merchant.

26. The system of claim 16, wherein the processing device is further configured to cause the mobile device of the consumer to output information associated with the one or more payment methods accepted by the first merchant by causing the mobile device to generate an audible sound associated with the one or more payment methods accepted by the first merchant.

27. The system of claim 16, wherein the one or more payment methods accepted by the first merchant comprise a digital wallet payment method.

28. The system of claim 27, wherein the processing device is further configured to:
responsive to an application associated with the digital wallet payment method being installed on the mobile device associated with the consumer, cause the mobile device associated with the consumer to execute the application associated with the digital wallet payment method; and
responsive to an application associated with the digital wallet payment method not being installed on the mobile device associated with the consumer, cause the mobile device associated with the consumer to generate a prompt requesting installation of one or more applications associated with the digital wallet payment method.

29. The system of claim 16, wherein the processing device is further configured to cause the mobile device of the consumer to output information associated with the one or more payment methods accepted by the first merchant by causing the mobile device of the consumer to output a prioritized list of payment methods accepted by the first merchant.

30. The system of claim 16, wherein:
the receiving device is further configured to receive product data associated with a plurality of products offered for sale by the first merchant; and
the processing device is further configured to cause the mobile device of the consumer to output information associated with the one or more payment methods accepted by the first merchant based on the received product data.
